(19) United States
(12) Patent Application Publication
(10) Pub. No.: US 2010/0262365 A1
(43) Pub. Date: Oct. 14, 2010

(54) MOBILE DEVICE WITH NAVIGATION FUNCTION AND METHOD THEREOF

(75) Inventors: HSIN-NAN HU, Tu-Cheng (TW); CHAO-FENG MA, Shenzhen City (CN); KUAN-HONG HSIEH, Tu-Cheng (TW); XIAO-GUANG LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HON FU JIN PRECISION INDUSTRY (Shenzhen) CO., LTD., Shenzhen City (CN); HON HAI PRECISION INDUSTRY CO., LTD., Tu-Cheng (TW)

(21) Appl. No.: 12/432,703

(22) Filed: Apr. 29, 2009

(30) Foreign Application Priority Data
Apr. 8, 2009 (CN) 200910301393.9

(51) Int. Cl. G01C 21/00

(52) U.S. Cl. 701/208

(57) ABSTRACT

A navigation method of the mobile device, wherein the mobile device comprises a GPS unit, the step comprising: receiving a message sent by an inviter mobile device; identifying whether the received message is an appointment message according to a message type flag in the message; determining an appointment location in the appointment message according to an address flag in the message; acquiring a map of the area including the location of the mobile device and the appointment location via the GPS unit; displaying the acquired map. A mobile device with navigation function is also provided.

### BACKGROUND

1. Technical Field

The present disclosure relates to a mobile device with a navigation function and a method thereof.

2. Description of Related Art

In general, mobile devices with Global Position System (GPS) navigation function are useful. For example, a user can input a departure location and destination into the mobile device, view a map of the area including the departure location and destination, and arrive at the destination according to the map. However, using a manual input method is not convenient and is time consuming, and prone to human error.

Therefore, what is needed is a mobile device with an automatic navigation function and a navigation method.

### BRIEF DESCRIPTION OF THE DRAWINGS

FIG. 1 is a schematic diagram of a system, including two mobile devices, for receiving and sending messages via a wireless network in accordance with an exemplary embodiment.

FIG. 2 is a block diagram of a hardware infrastructure of an invitee mobile device 20 of FIG. 1 in accordance with an exemplary embodiment.

FIG. 3 is a flowchart of a navigation method implemented by the invitee mobile device 20 of FIG. 2 in accordance with an exemplary embodiment.

### DETAILED DESCRIPTION

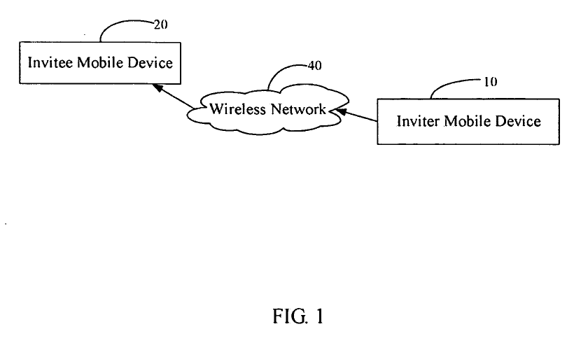

FIG. 1 is a schematic diagram of a system, including two mobile devices, for receiving and sending messages via a wireless network in accordance with an exemplary embodiment. In general, the system includes a plurality of inviter mobile devices 10, a plurality of invitee mobile devices 20, and a wireless network 40. In the exemplary embodiment, the disclosure only takes one inviter mobile device 10, and one invitee mobile device 20 to describe the principles of the invention. The invitee mobile device 20 is a mobile device with the Global Position System (GPS) navigation function. The inviter mobile device 10 communicates with the invitee mobile device 20 via the wireless network 40. The wireless network 40 can be General Packet Radio Service (GPRS) network, Global System for Mobile Communications (GSM) network, Code Division Multiple Access (CDMA) network, and so on.

When two or more users wants to appoint a place to meet, the inviter mobile device 10 will send an appointment message including an appointment location to an invitee mobile device 20. The invitee mobile device 20 obtains the appointment location from the appointment message, displays a map of the area including the location of the invitee mobile device 20 and the appointment location and route information to follow to the user.

The appointment message has a predetermined message format. That is, the appointment message includes a message type flag and an address flag.

The message type sign is configured to indicate the type of the appointment message. In the exemplary embodiment, there are two methods to indicate the message type. The first method is for automatically bundling predetermined content into the message heading of the appointment message to indicate the message type, such as “appointment message”, “invitation message”, and so on.

The second method is for setting a predetermined suffix to distinguish the appointment message from other type messages, such as, “.lrm”. In other exemplary embodiments, the inviter mobile device 10 can also apply other methods to indicate the type of the appointment message, for example, setting predetermined keywords in the appointment message to indicate the type of the appointment message.

The address sign is configured to indicate an appointment location in the appointment message. In the exemplary embodiment, there are two methods to indicate the appointment location. The first method automatically bundles predetermined keywords into the content of the message to indicate the appointment location. For example, when editing the appointment message, the predetermined keyword, such as “appointment”, will is automatically loaded into the content of the message; accordingly, the user can input the appointment location behind the predetermined keyword “appointment”.

The second method automatically indicates the appointment location to distinguish the appointment location from the content of the appointment message. For example, when the user edits the appointment, the appointment location will be automatically widened. In other exemplary embodiments, the inviter mobile device 10 can also apply other methods to indicate the appointment location.

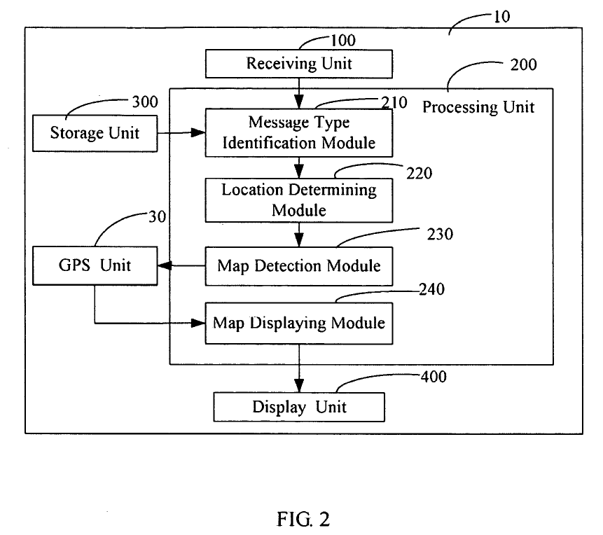

FIG. 2 is a block diagram of a hardware infrastructure of a invitee mobile device 20 of FIG. 1 in accordance with an exemplary embodiment. The invitee mobile device 20 includes a receiving unit 100, a processing unit 200, a storage unit 300, a display unit 400, and a GPS unit 500. The GPS unit 500 is configured to determine a current location or a route segment according to a received satellite signal. The receiving unit 100 is configured to receive messages sent by the inviter mobile device 10 or other mobile devices.

The processing unit 200 includes a message type identification module 210, a location determining module 220, a map detection module 230, and a map displaying module 240.

The message type identification module 210 is configured to identify whether the received message is an appointment message according to the message type flag. For example, the message type identification module 210 obtains the message heading or the suffix of the message to identify the message type.

In the exemplary embodiment, the processing unit 200 deals with the received message in a general manner if the message type identification module 210 identifies that the received message is not an appointment message. The general manner includes, but is not limited to, displaying the message, forwarding the message, or replying the message, and so on.

The location determining module 220 is configured to determine an appointment location in the appointment message according to the address flag. For example, the location determining module 220 identifies the predetermined keywords or the indication to determine the appointment location.

The map detection module 230 is configured to acquire a map of the area including the location of the invitee mobile device 20 and the appointment location via the GPS unit 500.

The map displaying module 240 is configured to display the acquired map on the display unit 400.

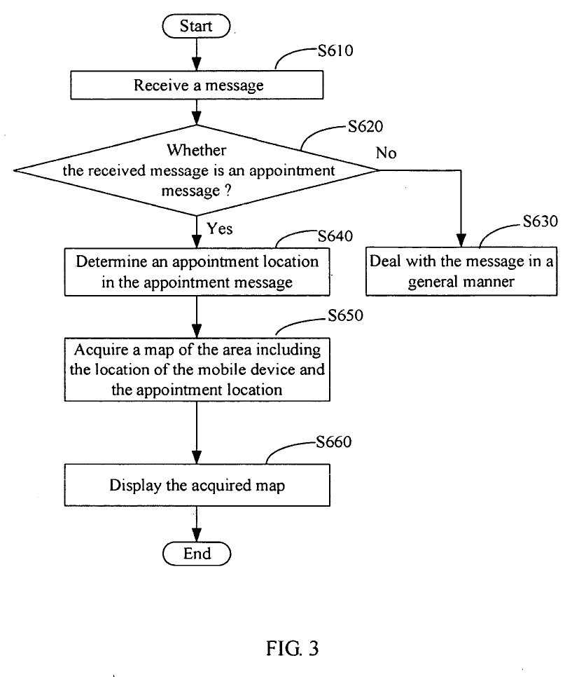

FIG. 3 is a flowchart of a navigation method implemented by the invitee mobile device 20 of FIG. 2 in accordance with an exemplary embodiment.

In step S610, the receiving unit 100 receives messages sent by the inviter mobile device 10 or other mobile devices.

In step S620, the message type identification module 210 identifies whether the received message is an appointment message according to the message type flag.

In step S630, the processing unit 200 deals with the received message in a general manner if the received message is not an appointment message.

In step S640, the location determining module 220 determines an appointment location in the appointment message according to the address flag if the received message is an appointment message.

In step S650, the map detection module 230 acquires a map of the area including the location of the invitee mobile device 20 and the appointment location via the GPS unit 500.

In step S660, the map displaying module 240 displays the acquired map on the display unit 400.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mobile device with navigation function, comprising:
a receiving unit capable of receiving messages sent by an inviter mobile device
a GPS unit;
a display unit; and
a processing unit comprising:
a message type identification module capable of identifying whether the received message is an appointment message according to a message type flag in the message;
a location determining module capable of determining a appointment location in the appointment message according to an address flag in the message;
a map detection module capable of acquiring a map of the area including the location of the mobile device and the appointment location via the GPS unit;
a map displaying module capable of displaying the acquired map on the display unit.

2. The mobile device as claim 1, wherein the message type identification module is capable of identifying whether the obtained content of the message heading includes the predetermined keywords according to the message type flag to determine whether the received message is an appointment message.

3. The mobile device as claim 1, wherein the message type identification module is capable of identifying whether the suffix of the received massage is a predetermined suffix according to the message type flag to determine whether the received message is an appointment message.

4. The mobile device as claim 1, wherein the location determining module is capable of identifying whether the appointment message includes the predetermined keywords indicating the appointment location according to an address flag to determine the appointment location in the appointment message.

5. The mobile device as claim 1, wherein the location determining module is capable of identifying whether the appointment message includes an indication indicating the appointment location according to an address flag to determine the appointment location in the appointment message.

6. A navigation method of the mobile device, wherein the mobile device comprises a GPS unit, the step comprising:
receiving a message sent by an inviter mobile device;
identifying whether the received message is an appointment message according to a message type flag in the message;
determining an appointment location in the appointment message according to an address flag in the message;
acquiring a map of the area including the location of the mobile device and the appointment location via the GPS unit;
displaying the acquired map.

7. The method as described in claim 6, wherein the identifying appointment message step further comprises:
identifying whether the obtained content of the message heading includes the predetermined keywords according to the message type flag to determine whether the received message is an appointment message.

8. The method as described in claim 6, wherein the identifying appointment message step further comprises:
identifying whether the suffix of the received massage is a predetermined suffix according to the message type flag to determine whether the received message is an appointment message.

9. The method as described in claim 6, wherein the determining appointment location step further comprises:
identifying whether the appointment message includes the predetermined keywords indicating the appointment location according to the address flag to determine the appointment location in the appointment message.

10. The method as described in claim 6, wherein the determining appointment location step further comprises:
identifying whether the appointment message includes an indication indicating the appointment location according to the address flag to determine the appointment location in the appointment message.
